(19) United States
(12) Patent Application Publication
(10) Pub. No.: US 2014/0191880 A1
(43) Pub. Date: Jul. 10, 2014

(54) SYSTEM, METHOD, AND SOFTWARE FOR AMBULATORY PATIENT MONITORING

(71) Applicant: COVIDIEN LP, Mansfield, MA (US)

(72) Inventors: Ken Benkert, Berthoud, CO (US); James C. Gibson, Greeley, CO (US)

(73) Assignee: COVIDIEN LP, Mansfield, MA (US)

(21) Appl. No.: 13/738,171

(22) Filed: Jan. 10, 2013

(51) Int. Cl. G08C 17/02

(52) U.S. Cl. CPC G08C 17/02
USPC 340/870.02

(57) ABSTRACT

A method for monitoring an ambulatory patient includes receiving a patient parameter from a medical device, and receiving a clinician parameter from a clinician device. The method further comprises analyzing the patient parameter, transforming the patient parameter and the clinician parameter into history parameters, and transforming the patient parameter into an audio parameter. The method further comprises transmitting the audio parameter to the clinician device, updating the history parameter in response to receiving a second patient parameter or a second clinician parameter, and updating the audio parameter in response to receiving a second patient parameter.

### TECHNICAL FIELD

The present disclosure relates generally to patient monitoring, and more particularly to a system, method, and software for ambulatory patient monitoring.

### BACKGROUND

When monitoring an ambulatory patient, a medical device may collect information about that patient and display the information on a screen; alternatively or simultaneously, the medical device may release an audible beep in response to detecting a pre-determined measurement. The medical device may collect information through one or more of a variety of ways, such as a patient interface that measures a physiological condition, or a user interface that collects information input by a user, and a user may analyze or interpret this information to assess and treat the health of the patient.

### SUMMARY

According to the present disclosure, disadvantages and problems associated with previous techniques for monitoring ambulatory patients may be reduced or eliminated.

In certain embodiments, a method of monitoring an ambulatory patient includes receiving at least one patient parameter from at least one medical device that has an interface for patient monitoring and an output for transmitting patient parameters. The method further includes receiving at least one clinician parameter from at least one clinician device that has an interface for receiving voice signals, an interface for receiving wireless electronic signals, and an output for transmitting clinician parameters. The method further includes analyzing the patient parameter and transforming the patient parameter and the clinician parameter into history parameters. The patient parameter is transformed into at least one audio parameter having a unit of measurement and/or a value indicating a physiological condition. The method further includes transmitting the audio parameter to the clinician device. The method further includes updating the history parameter in response to receiving a second patient parameter or a second clinician parameter, and updating the audio parameter in response to receiving a second patient parameter.

Certain embodiments of the present disclosure may provide one or more technical advantages that relate to improved methods of patient data delivery that are directed to providing audible parameters. For example, certain embodiments that implement audio parameters may enable clinicians to monitor ambulatory patients using an improved gurney without viewing a screen, thus ensuring that clinicians are better focused on the ambulatory patient. As another example, where multiple medical devices are used, certain embodiments enable a clinician to treat patients without viewing a cluttered screen. Certain embodiments may enable clinicians to treat patients without manually analyzing medical device output; for example, clinicians may hear the words “heart rate 89” instead of listening to beeps from a heart monitor and interpreting whether the beeps are within a desired frequency range, again enabling clinicians to remain focused on the patient.

Certain embodiments of the present disclosure may include some, all, or none of the above advantages. One or more other technical advantages may be readily apparent to those skilled in the art from the figures, descriptions, and claims included herein. Moreover, while specific advantages have been enumerated above, various embodiments may include all, some, or none of the enumerated advantages.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates an example system for ambulatory patient monitoring, according to certain embodiments of the present disclosure;

FIG. 2A illustrates an example host device and example clinician device of the system for ambulatory patient monitoring in FIG. 1, according to certain embodiments of the present disclosure;

FIG. 2B illustrates an example of one embodiment of the patient monitor in

FIG. 2A, according to certain embodiments of the present disclosure; and

FIG. 3 illustrates an example method for ambulatory patient monitoring, according to certain embodiments of the present disclosure.

### DETAILED DESCRIPTION

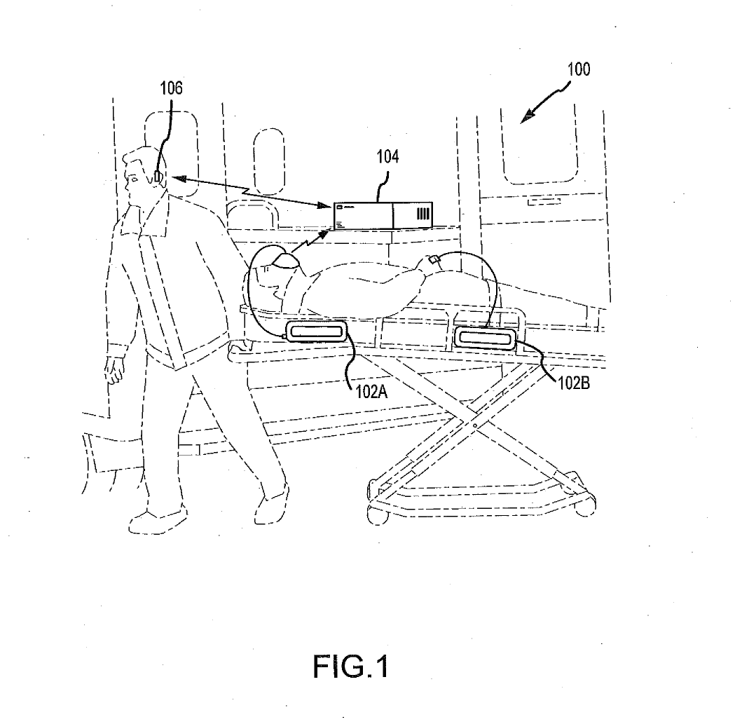

FIG. 1 illustrates an example system 100 for ambulatory patient monitoring, according to certain embodiments of the present disclosure. System 100 may include one or more medical devices 102 incorporated in an improved gurney, a host device 104, and a clinician device 106. Although this particular implementation of system 100 is illustrated and primarily described, the present disclosure contemplates any suitable implementation of system 100 according to particular needs.

System 100 may include one or more medical devices 102 incorporated in an improved gurney, as illustrated in FIG. 1. Medical devices 102 incorporated in the improved gurney may be any devices that are used for tracking or treating patients, and have an interface for patient monitoring and an output for transmitting patient parameters. As one example in the illustrated embodiment, medical device 102A may include a ventilator connected to a patient to deliver respiration therapy. As another example, medical device 102B in the illustrated embodiment may include a pulse oximeter that monitors the oxygen saturation of a patient's blood. As another example, medical devices 102 may include a device for tracking a patient without monitoring physiological conditions. The output of medical devices 102 may be a wireless transmission, wireline transmission, direct socket connection, or any other suitable output means. In short, medical devices 102 may include any suitable combination of software, firmware, and hardware used to support any medical function. It should be noted that any suitable number of medical devices 102 may be included in system 100. In addition, there may be multiple groups of medical devices 102 in system 100.

According to one embodiment, in addition to performing a medical function, medical devices 102 may generate output data tracked by medical devices 102. For example, a ventilator may generate entries indicating the average volume of air expelled in each breath, parameter settings used by the ventilator, and whether any alarms have been triggered. The ventilator may store the generated entries in local memory and output the entries. In some embodiments, medical devices 102 may generate output data that is related to tracking patient identifications or locations, without necessarily generating data related to a physiological condition. In certain embodiments, medical devices 102 may output data in response to a data request. In certain other embodiments, medical devices 102 may constantly stream output data.

Medical devices 102 may be communicatively coupled to host device 104 via a network, according to one embodiment. The network facilitates wireless or wireline communication. The network may communicate, for example, IP packets, Frame Relay frames, Asynchronous Transfer Mode (ATM) cells, voice, video, data, and other suitable information between network addresses. The network may include one or more personal area networks (PANs), local area networks (LANs), radio access networks (RANs), metropolitan area networks (MANs), wide area networks (WANs), all or a portion of the global computer network known as the Internet, and/or any other communication system or systems at one or more locations.

System 100 may include one or more host devices 104, referred to primarily in the singular throughout this disclosure. Host device 104 may include one or more electronic computing devices operable to receive, transmit, process, and store data associated with system 100. For example, host device 104 may include one or more general-purpose PCs, Macintoshes, workstations, Unix-based computers, server computers, one or more server pools, or any other suitable devices. In certain embodiments, host device 104 includes a web server. In short, host device 104 may include any suitable combination of software, firmware, and hardware. Although a single host device 104 is illustrated, the present disclosure contemplates system 100 including any suitable number of host devices 104. The present disclosure contemplates host device 104 comprising any suitable type of processing device or devices.

According to one embodiment, host device 104 receives patient parameters from at least one medical device 102. Patient parameters may refer to any patient identifiers, medical history, clinician notes, alarm thresholds, alarm events, device settings, measurements of values indicating physiological conditions such as oxygen saturation levels, pulse rates, heart rates, other vital signs, and any other output data from medical device 102. For example, host device 104 may request patient parameters from medical device 102 and receive patient parameters from medical device 102 in response to the request. As another example, host device 104 may receive streamed output data from medical device 102. As another example, host device 104 may be configured to periodically request new data from medical device 102.

Host device 104 may analyze the patient parameters from medical device 102 and transform the patient parameters into audio parameters and/or history parameters. Audio parameters may include an audible unit of measurement and/or a value indicating a physiological condition. For example, host device 104 may analyze signals from a heart monitor to determine a heart rate, systolic blood pressure, and diastolic blood pressure. Host device 104 may then transform the analyzed parameters into audio parameters, such as “heart rate 92, systolic 120, diastolic 90,” as well as history parameters which may include a time stamp and indication of the patient's heart rate, systolic blood pressure, and diastolic blood pressure at the time that host device 104 receives the patient parameters. It should be understood that the audio parameters may be in any form suitable for the clinician. For example, the language may be adjustable or pre-set, and the format may be selected to be efficient in ambulatory situations, such as “heart: 92, 120 over 80,” to allow the most information to be relayed in the least possible amount of time. As another example, the frequency of the parameters may be configured to be delivered at a faster or slower rate. In some embodiments, the configuration of the analysis at host device 104 may be audibly controlled clinician parameters received from clinician device 106. As one example, a clinician may speak into clinician device 106, with a command, such as “start record,” to initiate analysis by host device 104, including receiving, analyzing, and transforming patient parameters from medical device 102. At the end of treatment, a command such as “end record,” may cause host device 104 to cease receiving, analyzing and transforming patient parameters. As another example, a clinician parameter such as “transmit last breath flow” received from clinician device 106 may cause host device 104 to receive, analyze, and transform patient parameters from medical device 102A into audio parameters, and transmit the audio parameters to clinician device 106 without waiting for a pre-set time lapse and/or change in patient parameters.

According to one embodiment, host device 104 receives clinician parameters from clinician device 106 and transforms the clinician parameters into history parameters. For example, host device 104 may receive a voice recording indicating that the clinician has arrived at the scene of a medical emergency, and, upon receipt, may transform the clinician parameters into history parameters. As another example, the clinician parameters may include a keypad input by a clinician on clinician device 106, which is transformed by host device 104 into history parameters. The history parameters may be a data set including a recording of the clinician parameters and time stamp stored within host device 104, retrievable by a user for future review of events.

In certain embodiments, host device 104 updates the history parameters in response to receiving second patient parameters or second clinician parameters. Second patient parameters may be new parameters from a first medical device 102, such as medical device 102 described above, or second patient parameters may be new patient parameters from a second medical device 102 attached to the same patient, or a second patient. Similarly, second clinician parameters may be new parameters from a first clinician device 106, such as clinician device 106 described above, or second clinician parameters may be new clinician parameters from a second clinician device 106 related to a second clinician.

In certain embodiments, host device 104 may transmit the audio parameters to clinician device 106. The audio parameters are transmitted in human recognizable speech. In some embodiments, the human recognizable speech may be selected or changed by a user; in other embodiments, the human recognizable speech may be pre-set by the system manufacturer.

In certain embodiments, host device 104 updates the audio parameters in response to receiving second patient parameters. Where a second patient is being monitored, host device 104 may be operable to include in the audio parameters a patient identifier, such as “patient one,” or any other suitable identifier, so as to ensure clinicians are aware of which patient is associated with a particular audio parameter.

Where more than one clinician device 106 is included in system 100, host device 106 may be operable to distinguish between a first and second clinician device, and record history parameters separately. Host device 104 may further be operable to associate particular medical devices 102 with a first clinician device 106 and other medical devices 102 with a second clinician device 106. In some embodiments, host device 106 may group by patient, while clinician devices 106 may be grouped by patient or associated with all patients.

According to one embodiment, system 100 comprises at least one clinician device 106 operable to receive audio parameters from host device 104 and transmit clinician parameters to host device 104 in response to a voice signal. Clinician device 106 may be a Bluetooth headset or any device capable of receiving voice signals and transmitting clinician parameters in response to voice signals, as well as receiving audio parameters in electronic format and transmitting these in a sound format to a clinician. Clinician parameters may include voice recordings, voice prompts, connectivity records, or other clinician input, such as a keypad input. For example, a clinician may provide a voice input through clinician device 106, such as “initiating CPR,” and clinician device 106 may transmit a clinician parameter with this voice recording to host device 104. Host device 104 may transform this clinician parameter into a history parameter, possibly with a time stamp indicator, for recording and future reference. In some embodiments, a clinician may record a voice recording hands-free.

Although a single medical device 102, host device 104, and clinician device 106 are illustrated, the present disclosure contemplates system 100 including any suitable number of medical devices 102, host devices 104, and clinician devices 106. Moreover, although referred to as a host device 104, the present disclosure contemplates host device 104 comprising any suitable type of processing device or devices.

Although FIG. 1 depicts separate devices for medical device 102 and host device 104, it will be readily apparent that the functions of these devices may be combined into a single device that monitors a patient, analyzes patient parameters, transforms patient parameters into history parameters and audio parameters, transmits audio parameters to clinician device 106. It will also be understood that this single device may receive clinician parameters from clinician device 106 and transmit the audio parameters to clinician device 106. It will also be understood that the functions may be allocated differently than shown, with clinician device 106 additionally performing the functions of host device 104.

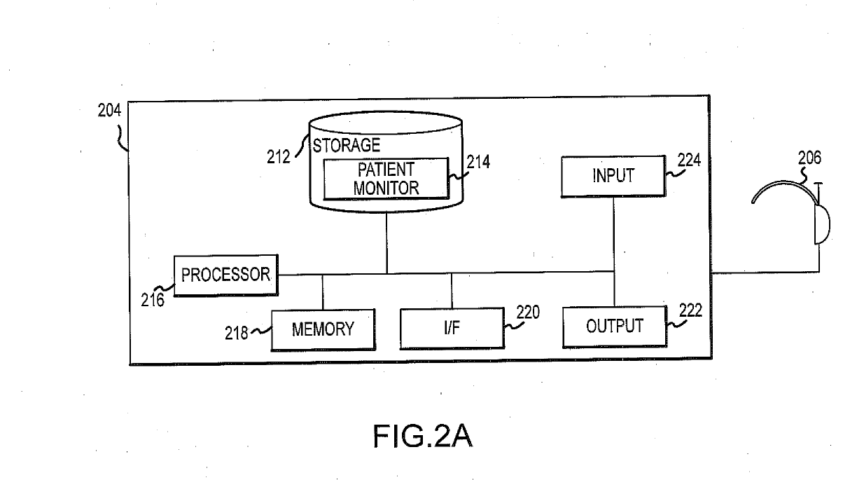

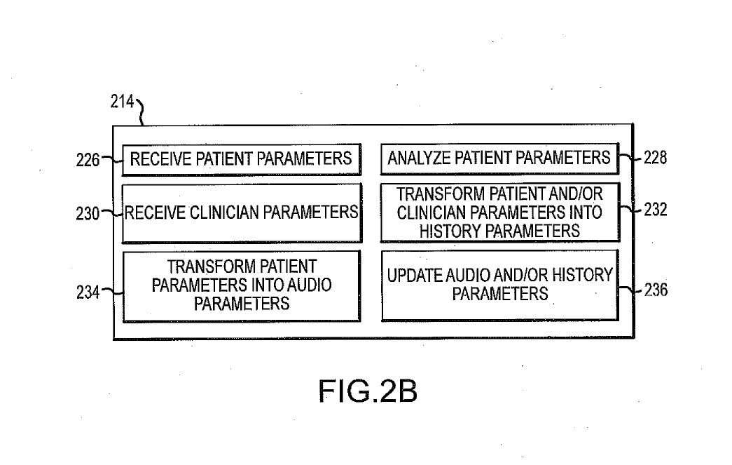

FIG. 2A illustrates an example host device 204 of the system 100 for ambulatory patient monitoring in FIG. 1, according to certain embodiments of the present disclosure. Host device 204 may be substantially similar to host device 104 of FIG. 1. In FIG. 2A, host device 204 is shown as a computing system communicatively coupled with a clinician device 206 having communications capability. Host device 210 includes a storage device 212, a patient monitor 214, a processor 216, a memory 218, a communication interface (I/F) 220, an output device 222, and an input device 224, which are discussed in further detail below. Although this particular implementation of host device 204 is illustrated and primarily described, the present disclosure contemplates any suitable implementation of host device 204 according to particular needs.

Storage device 212 may include any suitable device operable for storing .data and instructions. Storage device 212 may include, for example, a magnetic disk, flash memory, optical disk, or other suitable data storage device. Storage device 212 may store and facilitate delivery of patient parameters in a patient's history file to a doctor or caregiver when the patient arrives at the hospital. In certain embodiments, storage device 212 may facilitate access and transfer of patient parameters to another caregiver when the patient is transferred to a different theater or different facility.

Patient monitor 214 may include any suitable logic embodied in computer-readable media, and when executed, that is operable to transmit audio parameters to, and receive clinician parameters from, clinician device 206. For example, patient monitor 214 may include logic for receiving data from input device 224 and translating the data into audio parameters to be sent to clinician device 206. Patient monitor 214 may be configured to cause host device 204 to request periodically the most recent patient parameters from a medical device 102.

Output device 222 may include any suitable device operable for providing information to a user. Output device 222 may include, for example, a touch screen, a video display, a printer, a plotter, or other suitable output device. Output device 222 may further include a wireless transmission means to transmit parameters, such as those generated by patient monitor 214, to clinician device 206.

Processor 216 may include any suitable device operable to execute instructions and manipulate data to perform operations for patient monitor 214. Processor 216 may include, for example, any type of central processing unit (CPU).

Memory 218 may include any computer memory (for example, Random Access Memory (RAM) or Read Only Memory (ROM)), mass storage media (for example, a hard disk), removable storage media (for example, a Compact Disk (CD) or a Digital Video Disk (DVD)), .database and/or network storage (for example, a server). Memory 218 may comprise any other computer-readable tangible medium, or a combination of any of the preceding.

I/F 220 may include any suitable device operable to receive input for patient monitor 214, send output from patient monitor 214, perform suitable processing of the input or output or both, communicate to other devices, or any combination of the preceding. I/F 220 may include appropriate hardware (for example, a modem, network interface card, etc.) and software, including protocol conversion and data processing capabilities, to communicate through a LAN, WAN, or other communication system that allows patient monitor 214 to communicate to other devices. I/F 220 may include one or more ports, conversion software, or a combination of any of the preceding.

Input device 224 may include any suitable device operable to input, select, and/or manipulate various data and information. Input device 224 may include, for example, a touch screen, a keyboard, mouse, graphics tablet, joystick, light pen, microphone, scanner, or other suitable input device.

Modifications, additions, or omissions may be made to host device 204 without departing from the scope of the disclosure. The components of host device 204 may be integrated or separated. Moreover, the operations of host device 204 may be performed by more, fewer, or other components. For example, although patient monitor 214 is displayed as part of storage device 212, mobile monitor 214 may be stored in any suitable location and the operations of patient monitor 214 may be performed by more than one component. Additionally, operations of host device 204 may be performed using any suitable logic. As used in this document, “each” refers to each member of a set or each member of a subset of a set. Further details of an example host device 204 are provided below with reference to FIG. 2B.

FIG. 2B illustrates one embodiment of patient monitor 214, which may comprise logic for patient monitoring, and may be embodied in at least one tangible, computer-readable medium. For example, when the logic is executed, it may be operable to receive patient parameters 226 and analyze patient parameters 228 from medical device 102, medical device 102 comprising an interface for patient monitoring and an output for transmitting patient parameters. The logic may further receive clinician parameters 230 from clinician device 106, and transform the patient parameters and/or clinician parameters 232 into history parameters. The logic when executed may further transform patient parameters into audio parameters 234. The audio parameters may comprise at least one of a unit of measurement, and a value indicating a physiological condition. In some embodiments, the logic may further be operable to transmit audio parameters to clinician device 106. The logic may further be operable to update the history parameters and/or the audio parameters 236. History parameters are updated in response to receiving second patient parameters or second clinician parameters, and audio parameters are updated in response to receiving second patient parameters.

In certain embodiments, the logic may be operable to receive one or more second clinician parameters from a second clinician device, transmit at least one audio parameter to a first clinician device, and transmit at least one audio parameter to the second clinician device, wherein the at least one audio parameter transmitted to the first clinician device is related to a first medical device, and the at least one audio parameter transmitted to the second clinician device is related to a second medical device. The logic may be operable to transmit at least one audio parameter to at least one facilities device in certain embodiments. In certain other embodiments, the logic may be operable to receive the one or more first patient parameters and the one or more second patient parameters via wireless communication. The logic may be operable to receive the clinician parameters and transmit the audio parameters via wireless communication, in certain embodiments. In certain other embodiments, the logic for patient monitoring may be embodied in more than one tangible, computer-readable medium. For example, portions of the logic for patient monitoring may be embodied in one or more of host devices 104, medical devices 102, and facilities devices.

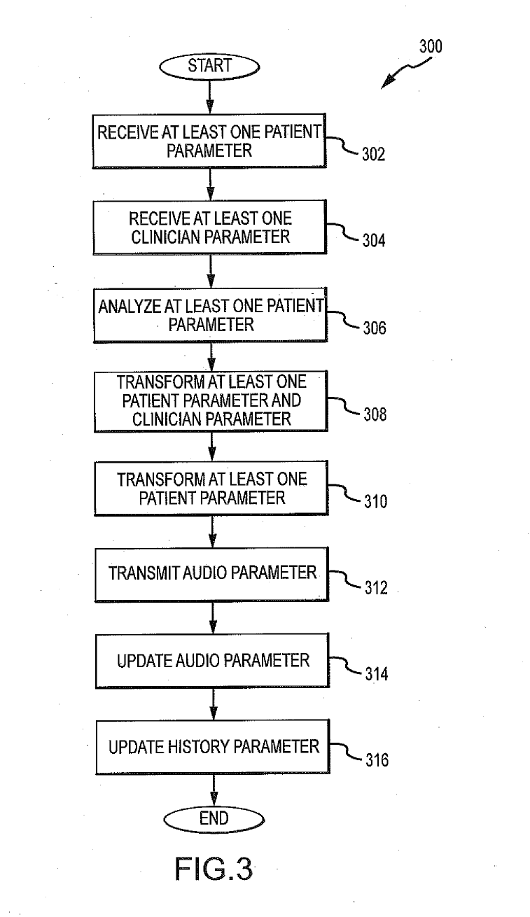

FIG. 3 illustrates an example method 300 for patient monitoring, according to certain embodiments. In some embodiments, method 300 may be achieved by a host device 104 imbedded within medical device 102, in wireline communication with medical device 102, or a separate device in wireless communication with medical device 102 as depicted in FIG. 1. Furthermore, some or all of the steps of the method illustrated in FIG. 3 may be performed by, for example, system 100, or logic embedded in a computer readable medium, such as that described with reference to FIG. 2B.

Method 300 begins at step 302 receiving at least one patient parameter from at least one medical device, the medical device comprising an interface for patient monitoring and an output for transmitting patient parameters. At step 304, at least one clinician parameter is received from at least one clinician device, the clinician device comprising an interface for receiving voice signals, an interface for receiving wireless electronic signals, and an output for transmitting clinician parameters. At step 306 the at least one patient parameter is analyzed. At step 308, the at least one patient parameter and the at least one clinician parameter are transformed into at least two history parameters. At step 310, the at least one patient parameter is transformed into at least one audio parameter comprising at least one of a unit of measurement, and a value indicating a physiological condition. At step 312, the at least one audio parameter is transmitted to the at least one clinician device. In some embodiments, transmitting may be performed in response to a change in the audio parameters or a lapse of time. At step 314, the at least one audio parameter is updated in response to receiving at least one second patient parameter. At step 316, the at least one history parameter is updated in response to receiving at least one second patient parameter or at least one second clinician parameter.

In some embodiments, the method may comprise receiving at least one second clinician parameter from a second clinician device, transmitting at least one audio parameter to a first clinician device, and transmitting at least one audio parameter to the second clinician device. The at least one audio parameter transmitted to the first clinician device may be related to a first medical device, and the at least one audio parameter transmitted to the second clinician device may be related to a second medical device.

In certain other embodiments, the method may comprise transmitting at least one audio parameter or history parameter to at least one facilities device, the facilities device comprising an interface for receiving wireless electronic signals and an output for parameters related to an ambulatory patient. The method may comprise analyzing the one or more first clinician parameters, in certain embodiments.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method, comprising the steps of:
receiving at least one patient parameter from at least one medical device, the medical device comprising an interface for patient monitoring and an output for transmitting patient parameters;
receiving at least one clinician parameter from at least one clinician device, the clinician device comprising an interface for receiving voice signals, an interface for receiving wireless electronic signals, and an output for transmitting clinician parameters;
analyzing the at least one patient parameter;
transforming the at least one patient parameter and the at least one clinician parameter into at least two history parameters;
transforming the at least one patient parameter into at least one audio parameter comprising at least one of a unit of measurement, and a value indicating a physiological condition;
transmitting the at least one audio parameter to the at least one clinician device;
updating the at least one audio parameter in response to receiving at least one second patient parameter; and
updating the at least one history parameter in response to receiving at least one second patient parameter or at least one second clinician parameter; and

2. The method of claim 1, further comprising:
receiving at least one second clinician parameter from a second clinician device;
transmitting at least one audio parameter to a first clinician device; and
transmitting at least one audio parameter to the second clinician device, wherein the at least one audio parameter transmitted to the first clinician device is related to a first medical device, and the at least one audio parameter transmitted to the second clinician device is related to a second medical device.

3. The method of claim 1, further comprising transmitting at least one audio parameter or history parameter to at least one facilities device, the facilities devise comprising an interface for receiving wireless electronic signals and an output for parameters related to an ambulatory patient.

4. The method of claim 1, further comprising analyzing the one or more first clinician parameters.

5. The method of claim 1, further comprising transmitting the one or more audio parameters in response to a change in the audio parameters, a lapse of time, and a clinician parameter.

6. The method of claim 1, wherein the one or more audio parameters comprise: at least one value indicating a physiological condition; and
at least one of an identifier related to the value indicating a physiological condition, a unit of measurement related to the value indicating a physiological condition, and an alatiii state related to the value indicating a physiological condition.

7. The method of claim 1, wherein the one or more first patient parameters and the one or more second patient parameters are received via wireless communication.

8. The method of claim 1, wherein the clinician parameters are received via wireless communication and the audio parameters are transmitted via wireless communication.

9. A system, comprising at least one clinician device and one or more processing units;
wherein the clinician device is operable to:
receive audio parameters from the one or more processing units; and
transmit clinician parameters to the one or more processing units in response to a. voice command; and
wherein the one or more processing units is operable to:
receive at least one patient parameter from at least one medical device, the medical device comprising an interface for patient monitoring and an output for transmitting patient parameters;
receive at least one clinician parameter from the at least one clinician device;
analyze the at least one patient parameter;
transform the at least one patient parameter and the at least one clinician parameter into at least two history parameters;
transform the at least one patient parameter into at least one audio parameter comprising at least one of a unit of measurement, and a value indicating a physiological condition;
transmit the at least one audio parameter to the at least one clinician device;
update the at least one history parameter in response to receiving at least one second patient parameter or at least one second clinician parameter; and
update the at least one audio parameter in response to receiving at least one second patient parameter.

10. The system of claim 9, wherein the one or more processing units, are operable to receive one or more second clinician parameters from a second clinician device, transmit at least one audio parameter to a first clinician device, and transmit at least one audio parameter to the second clinician device, wherein the at least one audio parameter transmitted to the first clinician device is related to a first medical device, and the at least one audio parameter transmitted to the second clinician device is related to a second medical device.

11. The system of claim 9, further comprising a facilities device operable to receive audio parameters and transmit sound, and wherein the one or more processing units are operable to transmit at least one audio parameter to at least one facilities device.

12. The system of claim 9, wherein the one or more processing units are operable to analyze the one or more first clinician parameters.

13. The system of claim 9, wherein the one or more processing units are operable to receive the one or more first patient parameters and the one or more second patient parameters via wireless communication.

14. The system of claim 9, wherein the one or more processing units are operable to receive the clinician parameters and transmit the audio parameters via wireless communication.

15. Logic embodied in at least one tangible, computer-readable medium and when executed operable to:
receive at least one patient parameter from at least one medical device, the medical device comprising an interface for patient monitoring and an output for transmitting patient parameters;
receive at least one clinician parameter from the at least one clinician device;
analyze the at least one patient parameter;
transform the at least one patient parameter and the at least one clinician parameter into at least two history parameters;
transform the at least one patient parameter into at least one audio parameter comprising at least one of a unit of measurement, and a value indicating a physiological condition;
update the at least one history parameter in response to receiving at least one second patient parameter or at least one second clinician parameter; and
update the at least one audio parameter in response to receiving at least one second patient parameter.

16. The logic of claim 15, when executed operable to transmit the at least one audio parameter to the at least one clinician device.

17. The logic of claim 15, when executed operable to receive one or more second clinician parameters from a second clinician device, transmit at least one audio parameter to a first clinician device, and transmit at least one audio parameter to the second clinician device, wherein the at least one audio parameter transmitted to the first clinician device is related to a first medical device, and the at least one audio parameter transmitted to the second clinician device is related to a second medical device.

18. The logic of claim 15, when executed operable to transmit at least one audio parameter to at least one facilities device.

19. The logic of claim 15, when executed operable to receive the one or more first patient parameters and the one or more second patient parameters via wireless communication.

20. The logic of claim 15, when executed operable to receive the clinician parameters and transmit the audio parameters via wireless communication.
